(19) United States
(12) Patent Application Publication
(10) Pub. No.: US 2026/0244403 A1
(43) Pub. Date: Aug. 20, 2026

(54) SPARSITY-AWARE COMPUTE-IN-MEMORY ARCHITECTURE WITH SELECTIVE COMPUTATION BYPASS

(71) Applicant: OpenAI Opco, LLC, San Francisco, CA (US)

(72) Inventors: Mohammed Elneanaei Abdelmoneem FOUDA, Alexandria, VA (US); Jackson Kwo-Chain HU, Atherton, CA (US)

(73) Assignee: OpenAI Opco, LLC, San Francisco, CA (US)

(21) Appl. No.: 19/542,353

(22) Filed: Feb. 17, 2026

Related U.S. Application Data
(60) Provisional application No. 63/759,886, filed on Feb. 18, 2025.

(51) Int. Cl. G06F 7/544; G06F 17/16

(52) U.S. Cl. CPC G06F 7/5443; G06F 17/16; G06F 2207/3868; G06F 2207/4824

(57) ABSTRACT

The disclosure is directed to a digital compute-in-memory (DCIM) architecture that detects zero-valued operands and selectively bypasses computations when the result is predetermined to be zero. The architecture includes a weight memory, an input register, multipliers, an adder tree, and an output register. Zero detection circuitry generates zero-weight indicators and zero-activation indicators based on weight values and activation values. Selector circuitry selects an output based on the zero indicators, enabling computational bypass when products are predetermined to be zero. Power gating circuitry selectively disables power to multipliers and adders based on zero-weight indicators. The architecture employs a weight-stationary dataflow, enabling power gating states to be set when weight values are loaded and maintained while successive activation values are processed.

### CROSS-REFERENCE TO RELATED APPLICATIONS

This application claims the benefit, pursuant to 35 U.S.C. § 119(e) and 37 C.F.R. § 1.78(a), of U.S. Provisional Application No. 63/759,886, filed Feb. 18, 2025. The disclosure of U.S. Provisional Application No. 63/759,886 is hereby incorporated by reference herein in its entirety.

### BACKGROUND

Artificial intelligence (AI) and machine learning applications demand substantial computational throughput, requiring rapid inference cycles and sustained high-performance processing. To meet these requirements, multiply and accumulate operations form the computational foundation of neural network layers, attention mechanisms, and other data parallel algorithms. As model sizes and dataset complexities continue to grow, the underlying hardware must perform billions of multiply-accumulate operations per second while maintaining energy efficiency and accuracy.

These workloads impose substantial demands on computing systems. Each processing element must support high data bandwidth and large computations while maintaining timing accuracy and power efficiency. In high-density configurations, such as server racks and compute nodes in data centers, multiple processing elements may operate in close proximity, compounding the power constraints and thermal limitations. Efficient power management therefore becomes a critical consideration in the design of such computing systems.

Achieving power-efficient neural network inference while maintaining computational accuracy remains a central challenge in high-performance computing, as conventional architectures struggle to balance compute density, power consumption, and sparsity exploitation at scale. Conventional compute-in-memory (CIM) architectures perform multiplication and addition operations regardless of operand values, consuming power even when the resulting output does not contribute meaningful information. Neural network models often exhibit sparsity, where a significant fraction of weight values or activation values lacks significance, yet conventional architectures fail to exploit this sparsity to reduce power consumption. These inefficiencies are amplified in AI workloads where multiply-accumulate operations are frequent and power consumption is a critical resource.

### SUMMARY

The disclosed technology addresses these challenges through a digital compute-in-memory (DCIM) architecture that detects zero-valued operands and selectively bypasses computations when the result is predetermined to be zero. Such a configuration can improve computation efficiency by skipping certain operations and minimizing redundancies. The architecture includes a weight memory configured to store weight values, an input register configured to receive activation values, multiple multipliers coupled to the weight memory and the input register, and at least one adder tree coupled to the multipliers. The architecture further includes zero detection circuitry configured to generate zero-weight indicators and zero-activation indicators, and selector circuitry configured to select an output based on the zero indicators.

The selector circuitry may be configured to select the output from a zero value, a product from one of the multipliers, or an output of the adder tree. When zero-weight indicators and zero-activation indicators indicate that all products are zero, the selector circuitry may output a zero value directly, bypassing the multipliers and adder tree. In some implementations, the architecture further includes power gating circuitry configured to gate unused computational elements based on zero operand detection, reducing dynamic power consumption without affecting computational accuracy.

The disclosed technology employs a weight-stationary dataflow in which weight values remain stored in the weight memory while the input register receives successive sets of activation values. The zero-weight indicators may be generated when weight values are loaded into the weight memory, enabling power gating states to be determined before activation values are received. This approach allows the power gating circuitry to set a power gating state when weight values are loaded and maintain the power gating state while successive activation values are processed, reducing control overhead during inference operations.

In some implementations, the multipliers include floating-point multiplication circuitry with alignment circuitry for aligning operands or products. The selector circuitry may be configured to bypass the alignment circuitry based on the zero-weight indicators and the zero-activation indicators. When a product is predetermined to be zero, the alignment circuitry need not perform shifting operations, and the selector circuitry may route an alternative value directly to the output. The alignment circuitry may also be power gated based on the zero-weight indicators, further reducing power consumption when alignment operations are unnecessary.

In another example, a method for performing vector-matrix multiplication (VMM) may include storing weight values in a weight memory, receiving activation values in an input register, generating zero-weight indicators and zero-activation indicators, multiplying the activation values by the weight values using multiple multipliers, summing products using at least one adder tree, and selecting an output based on the zero indicators. The method may further include setting a power gating state of at least one multiplier based on the zero-weight indicators when storing the weight values in the weight memory.

In yet another example, a multiply-accumulate unit may include weight storage storing weight values, multiple multipliers coupled to the weight storage and configured to receive activation values, and an adder coupled to the multipliers. The multiply-accumulate unit may further include zero detection circuitry and selector circuitry configured to select an output based on zero-weight indicators and zero-activation indicators. Power gating circuitry may be configured to gate at least one of the multipliers or the adder based on the zero-weight indicators.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates a diagram of an example of a digital compute-in-memory (DCIM) architecture including an input register, weight memory, multipliers, and adder trees, in accordance with some aspects of the present technology.

FIG. 2 illustrates a diagram of an example of an integer multiply-accumulate unit with selector circuitry and zero detection circuitry, in accordance with some aspects of the present technology.

FIG. 3 illustrates a diagram of an example of a floating-point multiply-accumulate unit with alignment circuitry, selector circuitry and zero detection circuitry, in accordance with some aspects of the present technology.

FIG. 4 illustrates a flow chart of an example of a method for performing vector-matrix multiplication with zero-skipping, in accordance with some aspects of the present technology.

FIG. 5 illustrates a table of an example of selector logic for a multiply-accumulate unit showing output selection based on zero indicators, in accordance with some aspects of the present technology.

### DETAILED DESCRIPTION

The following disclosure provides various embodiments and examples for implementing features of the invention. Specific examples of components and arrangements are described to simplify the present disclosure. These examples are not intended to be limiting. For instance, the formation of a first feature over or on a second feature may include embodiments in which the two features are in direct contact, as well as embodiments in which additional features are interposed between them. Reference numerals and/or letters may be repeated across examples for clarity and simplicity, and such repetition does not imply a specific relationship between embodiments.

Some of the disclosed embodiments are described with reference to the accompanying drawings. However, it will be understood by those skilled in the art that the principles of the example methods and systems may be practiced without every specific detail. Well-known methods, procedures, and components have not been described in detail so as not to obscure the principles of some of the disclosed methods and systems. Unless explicitly stated, the example methods and processes described herein are neither constrained to a particular order or sequence nor constrained to a particular system configuration. Additionally, some of the described methods and systems or elements thereof can occur or be performed (e.g., executed) simultaneously, at the same point in time, or concurrently. Reference will now be made in detail to some of the disclosed methods and systems, examples of which are illustrated in the accompanying drawings.

It is to be understood that both the foregoing general description and the following detailed description are only explanatory and are not restrictive of this disclosure. The accompanying drawings, which are incorporated in and constitute a part of this specification, illustrate several disclosed methods and systems and together with the descriptions serve to outline principles of some of the disclosed methods and systems.

Spatially relative terms such as “beneath,” “below,” “lower,” “above,” “upper,” and similar descriptors are used for convenience in describing the relative positioning of elements as illustrated in the figures. These terms are intended to encompass different orientations of the device in use or operation, and should not be interpreted as limiting the scope of the invention to the depicted orientation.

Modern artificial intelligence (AI) applications, particularly neural network inference workloads, demand substantial computational throughput while operating under strict power constraints. Vector-matrix multiply (VMM) operations are fundamental computations for many neural network computations, including fully connected layers and attention mechanisms. As model sizes continue to grow, computing systems must efficiently execute large-scale VMM operations while minimizing power consumption.

Efficient neural network inference requires addressing power efficiency challenges, particularly in multiply-accumulate operations that dominate computational workloads. Neural network models often exhibit sparsity, where a significant fraction of weight values or activation values are zero. Conventional compute-in-memory architectures perform multiplication and addition operations regardless of operand values, consuming power even when the result is predetermined to be zero. Accordingly, there is a need for computing architectures that detect zero-valued operands and selectively bypass or power gate computational circuitry to reduce power consumption.

The disclosed technology provides a digital compute-in-memory (DCIM) architecture for performing VMM operations with reduced power consumption. The architecture detects zero-valued operands in multiply-accumulate operations and selectively bypasses computations when the result is predetermined to be zero. In some implementations, the architecture further includes power gating circuitry configured to gate unused computational elements based on zero operand detection, reducing dynamic power consumption. This approach enables power-efficient neural network inference by exploiting sparsity in weight values and activation values without affecting computational accuracy.

Neural network models often exhibit significant sparsity in both weight values and activation values. Weight sparsity may arise from pruning techniques that remove low-magnitude weights to reduce model size and computational requirements. Activation sparsity commonly results from rectified linear unit (ReLU) activation functions, which output zero for all negative inputs. Quantization techniques that reduce numerical precision may also increase sparsity by mapping small values to zero. Exploiting this inherent sparsity presents an opportunity to reduce computational workload and power consumption in neural network inference hardware.

Power consumption in digital circuits includes dynamic power and static power components. Dynamic power arises from switching activity when transistors change state, and is proportional to the switching frequency and the capacitance being charged or discharged. Static power, also referred to as leakage power, flows even when circuits are idle due to subthreshold conduction in transistors. In high-performance computing systems, dynamic power often dominates during active computation, making reduction of unnecessary switching activity a target for power optimization. Power gating techniques can reduce both dynamic and static power by disconnecting unused circuit blocks from the power supply.

Compute-in-memory architectures address the memory bandwidth bottleneck by performing computations within or near the memory array, reducing the need to transfer data between separate memory and processing units. In conventional architectures, data movement between memory and processors consumes significant energy and limits throughput. DCIM architectures integrate digital logic with memory arrays to perform operations such as multiplication and addition at or near the memory location where operands are stored. This approach reduces data movement energy and enables higher computational throughput for data-parallel workloads such as neural network inference.

Neural network accelerators employ various dataflow strategies to optimize data reuse and minimize memory accesses. In a weight-stationary dataflow, weight values are loaded into local storage and remain stationary while activation values stream through the processing elements. This approach maximizes weight reuse across multiple activation vectors, reducing memory bandwidth requirements for weight fetches. Alternative dataflows include output-stationary, where partial output values remain stationary while inputs stream through, and input-stationary, where input activations remain stationary while weights stream through. The choice of dataflow affects memory access patterns, on-chip storage requirements, and overall energy efficiency.

Multiply-accumulate operations form the computational core of neural network inference. A single multiply-accumulate operation multiplies two operands and adds the result to an accumulator. Neural network layers such as fully connected layers, convolutional layers, and attention mechanisms can be expressed as collections of multiply-accumulate operations organized as vector-matrix multiplications or matrix-matrix multiplications. The high volume of multiply-accumulate operations in neural network inference makes the efficiency of individual multiply-accumulate units a factor in overall system performance and power consumption.

In one example, a computing system may include a weight memory configured to store weight values, an input register configured to receive activation values, multiple multipliers coupled to the weight memory and the input register, and at least one adder tree coupled to the multipliers. The computing system may further include an output register configured to store results from the adder tree. The weight memory may be implemented using static random-access memory (SRAM) cells, latches, or other suitable storage elements. The computing system may employ a weight-stationary dataflow in which the weight values remain stored in the weight memory while the input register receives successive sets of activation values. As used herein, weight-stationary dataflow refers to an operational mode in which weight values are loaded once and reused across multiple activation vectors, reducing memory bandwidth requirements for weight fetches.

The computing system may include zero detection circuitry configured to generate zero-weight indicators based on the weight values and zero-activation indicators based on the activation values. As used herein, a zero-weight indicator may be a signal indicating that a corresponding weight value is equal to zero, and a zero-activation indicator may be a signal indicating that a corresponding activation value is equal to zero. The zero-weight indicators may respectively correspond to the weight values, and the zero-activation indicators may respectively correspond to the activation values.

In some embodiments, the zero detection circuitry may generate the zero-weight indicators when weight values are loaded into the weight memory, enabling power gating states to be determined before activation values are received. The zero-activation indicators may be generated dynamically as successive sets of activation values are received in the input register.

The computing system may further include selector circuitry coupled to the multipliers and the adder tree. The selector circuitry may be configured to select an output based on the zero-weight indicators and the zero-activation indicators. In some implementations, the selector circuitry may be configured to select the output from: a zero value, a product from one of the multipliers, or an output of the adder tree. When the zero-weight indicators and zero-activation indicators indicate that all products of the multipliers are zero, the selector circuitry may output a zero value directly, bypassing the multipliers and adder tree. The selector circuitry may be implemented using a lookup table, a multiplexer, or combinational logic configured to determine the appropriate output based on the zero indicators. This selection mechanism enables computational bypass when operands are zero, reducing switching activity and power consumption.

The computing system may further include power gating circuitry configured to selectively disable power to computational elements based on the zero indicators. In some implementations, the power gating circuitry may be configured to power gate one or more multipliers based on corresponding zero-weight indicators. Because the weight values remain stationary in the weight memory during operation, the power gating circuitry may set a power gating state when weight values are loaded into the weight memory, and the power gating state may remain constant while successive sets of activation values are processed.

The power gating circuitry may also be configured to power gate one or more adders in the adder tree when the adders are configured to pass through an input. By disabling power to multipliers and adders that would otherwise perform computations with zero-value operands, the power gating circuitry reduces dynamic power consumption without affecting computational results.

Power gating circuitry may be implemented using various techniques. In some implementations, the power gating circuitry may include header switches comprising p-type metal-oxide-semiconductor (PMOS) transistors connected between a supply voltage and the computational circuitry. When a header switch is turned off, the supply voltage is disconnected from the associated multiplier or adder, reducing both dynamic power consumption from switching activity and static power consumption from leakage currents.

In other implementations, the power gating circuitry may include footer switches comprising n-type metal-oxide-semiconductor (NMOS) transistors connected between the computational circuitry and a ground reference. Footer switches disconnect the ground path when turned off, similarly reducing power consumption in the gated circuitry.

In some implementations, the power gating circuitry may include clock gating circuitry configured to selectively disable a clock signal to computational elements. Clock gating reduces dynamic power consumption by preventing switching activity in the gated circuitry while the clock signal is disabled. Clock gating may be used alone or in combination with power gating using header or footer switches. The power gating circuitry may include isolation circuitry configured to clamp outputs of power-gated blocks to defined logic levels, preventing undefined or floating outputs from affecting downstream circuitry.

The adder tree may include multiple adders, where each adder is configured to pass through an input when another input to the adder is zero. As used herein, pass-through refers to an operational mode in which an adder outputs one of its input values directly without performing an addition operation.

In some implementations, each adder may be associated with a multiplexer configured to selectively route either an output of the adder or a bypass input directly to the next stage. When a zero-weight indicator or zero-activation indicator indicates that a product is zero, the multiplexer may bypass the adder and output the non-zero input directly. This pass-through capability may be combined with power gating, such that an adder configured to pass through an input may also be power gated to further reduce power consumption. The pass-through mechanism enables efficient handling of sparse data by avoiding unnecessary addition operations.

In some aspects, the disclosed technology may be implemented as a multiply-accumulate unit for integer operations. The multiply-accumulate unit may include weight storage configured to store weight values, multiple multipliers coupled to the weight storage and configured to receive activation values, and an adder coupled to the multipliers. The multiply-accumulate unit may further include zero detection circuitry configured to generate zero-weight indicators and zero-activation indicators, and selector circuitry configured to select an output based on the zero indicators.

The selector circuitry may be configured to select the output from a zero value, a product from one of the multipliers, or an output of the adder. The multiply-accumulate unit may also include power gating circuitry configured to gate one or more of the multipliers or the adder based on the zero-weight indicators. This configuration enables power-efficient multiply-accumulate operations for integer data types commonly used in quantized neural network inference.

The multiply-accumulate unit may be scaled to include more than two multipliers. In some implementations, a multiply-accumulate unit may include N multipliers, where N is an integer greater than two, coupled to an adder tree having multiple levels of adders. The zero detection circuitry may generate N zero-weight indicators and N zero-activation indicators respectively corresponding to the N weight values and N activation values. As the number of multipliers increases, the selector circuitry may select an output from a correspondingly larger set of possible values, including partial sums from intermediate levels of the adder tree.

In some implementations, multiple multiply-accumulate units may be combined hierarchically to form larger computational blocks. A first multiply-accumulate unit and a second multiply-accumulate unit may each produce an output, and an additional adder may sum the outputs to produce a combined result. The zero detection and selection logic may be applied at each level of the hierarchy, enabling zero-skipping at both the individual multiply-accumulate unit level and the combined output level.

In some implementations, the zero-skipping functionality may be selectively enabled or disabled based on workload characteristics. The computing system may include control circuitry configured to enable or disable the selector circuitry and the power gating circuitry based on a control signal or configuration register. For workloads with high sparsity, the zero-skipping functionality may be enabled to reduce power consumption. For workloads with low sparsity, the zero-skipping functionality may be disabled to reduce control overhead.

In some embodiments, the multipliers may include floating-point multiplication circuitry with alignment circuitry for aligning operands or products. As used herein, alignment circuitry refers to shifting logic that adjusts the mantissa of a floating-point value based on exponent differences to enable proper addition of floating-point products. The selector circuitry may be configured to bypass the alignment circuitry based on the zero-weight indicators and the zero-activation indicators. When a product is predetermined to be zero, the alignment circuitry need not perform shifting operations, and the selector circuitry may route an alternative value directly to the output.

The alignment circuitry may also be power gated based on the zero-weight indicators, further reducing power consumption (e.g., minimizing leakage and/or dynamic switching) when alignment operations are unnecessary. In some implementations, the weight values and activation values may include block floating-point values with shared scales, where multiple values share a common exponent or scale factor. Block floating-point formats reduce the complexity of alignment operations while maintaining numerical accuracy for neural network computations.

In some implementations, the floating-point multiplication circuitry may handle subnormal values by determining the implicit leading bit based on the exponent field. Subnormal values, which have an exponent field of all zeros, use an implicit leading bit of zero, whereas normal values use an implicit leading bit of one.

The disclosed architecture provides several advantages for neural network inference workloads. By detecting zero-valued operands and bypassing unnecessary computations, the architecture reduces dynamic power consumption proportionally to the sparsity of the weight and activation values. The weight-stationary dataflow enables power gating decisions to be made once when weights are loaded, avoiding the overhead of dynamic power gating control. The selector circuitry enables computational bypass without requiring changes to the data format or numerical precision, maintaining compatibility with existing neural network models and training frameworks.

The disclosed technology may be applied in various computing environments. In data center deployments, the power savings from zero-skipping may reduce cooling requirements and operating costs for large-scale neural network inference. In edge computing devices, the reduced power consumption may extend battery life or enable deployment in power-constrained environments. The architecture may be implemented in application-specific integrated circuits (ASICs) and field-programmable gate arrays (FPGAs).

Other aspects of the disclosed technology are directed to methods for performing VMM with reduced power consumption. The method may include storing weight values in a weight memory, receiving activation values in an input register, and generating zero-weight indicators for the weight values and zero-activation indicators for the activation values. The method may further include multiplying the activation values by the weight values using multiple multipliers, summing products from the multipliers using an adder tree, and selecting an output based on the zero-weight indicators and the zero-activation indicators.

In some implementations, the weight values may be maintained stationary in the weight memory while the input register receives successive sets of activation values. The method may further include setting a power gating state of one or more multipliers based on the zero-weight indicators when storing the weight values in the weight memory. By generating the zero-weight indicators at weight load time, the power gating states may remain constant across multiple activation vectors, reducing control overhead during inference operations.

Yet other aspects of the disclosed technology are directed to a multiply-accumulate unit as a standalone component. The multiply-accumulate unit may include weight storage, multiple multipliers coupled to the weight storage, and an adder coupled to the multipliers. The multiply-accumulate unit may further include zero detection circuitry and selector circuitry as described above. This multiply-accumulate unit may be implemented for integer operations, floating-point operations, or block floating-point operations, and may be integrated into a larger computing system or deployed as a discrete processing element.

Reference is now made to the drawings, which depict illustrative, non-limiting examples provided to facilitate understanding of the subject matter disclosed. The figures are not drawn to scale and are presented for explanatory purposes. Like reference numerals refer to like elements throughout the views. Features shown in connection with a particular figure or embodiment may be combined with, substituted for, or omitted relative to features shown in other figures. Certain conventional elements may be simplified or not shown to avoid obscuring pertinent details. Positional terms (e.g., “upper,” “lower,” “front,” “rear”) are used for convenience of description and do not imply a required orientation. Flow diagrams may represent operations that can be performed in different orders, in parallel, with steps added or omitted.

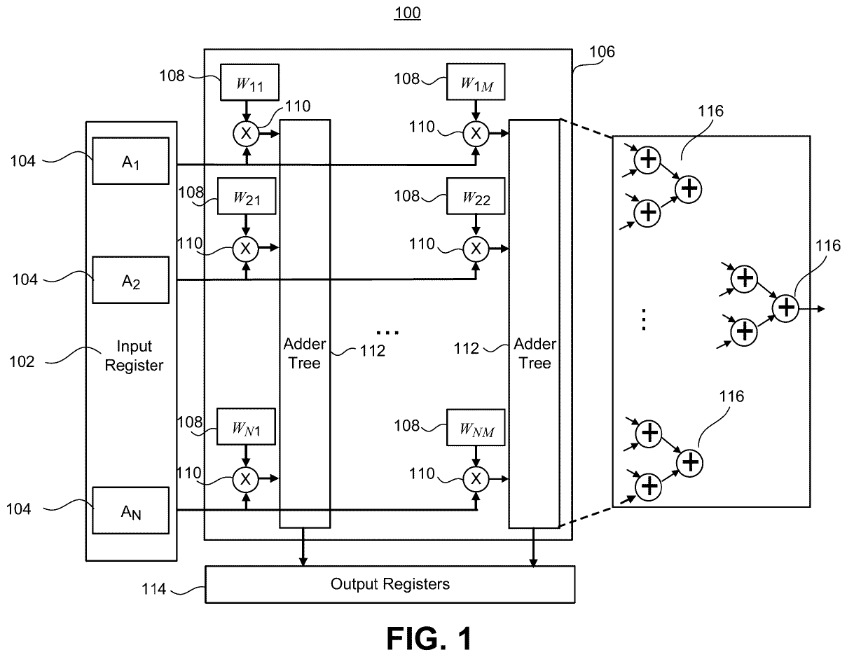

FIG. 1 illustrates a diagram of an example of a digital compute-in-memory (DCIM) system 100, in accordance with some aspects of the present technology. DCIM system 100 may be configured to perform VMM operations for neural network inference. As shown in FIG. 1, DCIM system 100 may include an input register 102, a weight memory 106, multipliers 110, adder trees 112, and an output register 114.

Input register 102 may be configured to receive and store activation values 104. Activation values 104 may include values A₁, A₂, through A_{N}, representing elements of an input vector for the VMM operation. Input register 102 may receive successive sets of activation values 104 during operation, while weight values 108 remain stationary in weight memory 106. Input register 102 may be coupled to multipliers 110 and configured to provide activation values 104 to the multipliers 110.

Weight memory 106 may be configured to store weight values 108. Weight values 108 may be arranged as a matrix with elements Wᵢⱼ, where i denotes a row index and j denotes a column index. Weight memory 106 may be implemented using SRAM cells, latches, or other suitable storage elements. In a weight-stationary dataflow, weight values 108 may be loaded into weight memory 106 once and remain stored while input register 102 receives multiple successive sets of activation values 104. Weight memory 106 may be coupled to multipliers 110 and configured to provide weight values 108 to the multipliers 110.

Multipliers 110 may be coupled to input register 102 and weight memory 106. Each multiplier of multipliers 110 may be configured to multiply an activation value from activation values 104 with a corresponding weight value from weight values 108 to produce a product. As shown in FIG. 1, multipliers 110 may be arranged in an array configuration corresponding to the dimensions of the weight matrix. The products from multipliers 110 may be provided to adder trees 112 for summation.

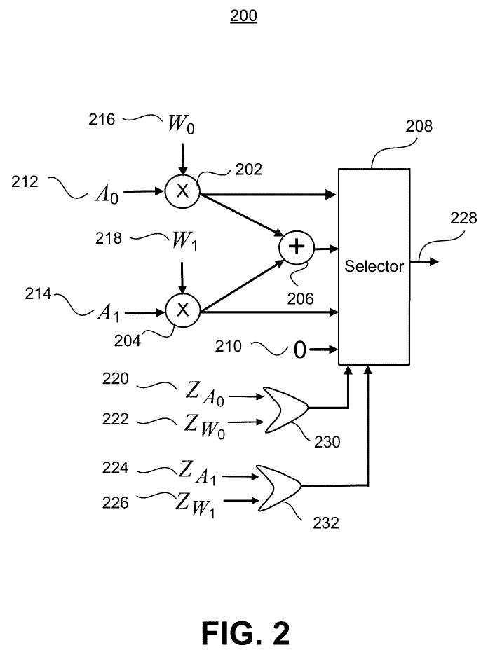

Adder trees 112 may be coupled to multipliers 110 and configured to sum products from the multipliers 110. Each adder tree of adder trees 112 may include multiple adders 116 arranged in a tree structure. Adders 116 may receive products from corresponding multipliers 110 and produce partial sums that propagate through the tree structure to generate a final sum. As further described with reference to FIG. 2, adders 116 may be configured to pass through an input when another input to the adder is zero. The outputs of adder trees 112 may be provided to output register 114.

Output register 114 may be coupled to adder trees 112 and configured to receive and store results from the adder trees 112. Output register 114 may store the output vector resulting from the VMM operation. The results stored in output register 114 may be provided to subsequent processing stages or memory for further computation.

DCIM system 100 may further include control circuitry (not shown) configured to coordinate the operation of input register 102, weight memory 106, multipliers 110, adder trees 112, and output register 114. The control circuitry may generate timing signals to synchronize data flow through the system and may interface with external memory controllers to manage loading of weight values and streaming of activation values. In some implementations, DCIM system 100 may include multiple instances of the illustrated components arranged in parallel to increase computational throughput.

FIG. 2 illustrates a diagram of an example of a multiply-accumulate unit 200 with zero detection and selector circuitry, in accordance with some aspects of the present technology. Multiply-accumulate unit 200 may be implemented within DCIM system 100 (FIG. 1) as one of the multipliers 110 and associated adder circuitry. As shown in FIG. 2, multiply-accumulate unit 200 may include a first multiplier 202, a second multiplier 204, an adder 206, a selector 208, zero detection gates 230 and 232, and associated inputs and outputs.

Multiply-accumulate unit 200 may receive a first activation input A₀ 212, a second activation input A₁ 214, a first weight input W₀ 216, and a second weight input W₁ 218. First activation input A₀ 212 and second activation input A₁ 214 may be received from input register 102 (FIG. 1). First weight input W₀ 216 and second weight input W₁ 218 may be received from weight memory 106 (FIG. 1). In a weight-stationary dataflow, weight inputs W₀ 216 and W₁ 218 may remain constant while activation inputs A₀ 212 and A₁ 214 receive successive values.

First multiplier 202 may be coupled to first activation input A₀ 212 and first weight input W₀ 216, and configured to produce a first product A₀W₀. Second multiplier 204 may be coupled to second activation input A₁ 214 and second weight input W₁ 218, and configured to produce a second product A₁W₁. The products from first multiplier 202 and second multiplier 204 may be provided to adder 206 for summation.

Adder 206 may be coupled to first multiplier 202 and second multiplier 204, and configured to sum the first product and the second product to produce a sum A₀W₀+A₁W₁. Adder 206 may be configured to pass through an input when another input to adder 206 is zero. For example, when the first product is zero, adder 206 may pass through the second product directly without performing an addition operation.

Multiply-accumulate unit 200 may include zero detection circuitry configured to generate zero indicators based on the input values. As shown in FIG. 2, the zero indicators may include a first zero-activation indicator Z_{A0} 220, a first zero-weight indicator Z_{W0} 222, a second zero-activation indicator Z_{A1} 224, and a second zero-weight indicator Z_{W1} 226. First zero-activation indicator Z_{A0} 220 may indicate whether first activation input A₀ 212 is equal to zero. First zero-weight indicator Z_{W0} 222 may indicate whether first weight input W₀ 216 is equal to zero. Second zero-activation indicator Z_{A1} 224 may indicate whether second activation input A₁ 214 is equal to zero. Second zero-weight indicator Z_{W1} 226 may indicate whether second weight input W₁ 218 is equal to zero.

First zero detection gate 230 and second zero detection gate 232 may be configured to generate control signals for selector 208 based on the zero indicators. First zero detection gate 230 may receive first zero-activation indicator Z_{A0} 220 and first zero-weight indicator Z_{W0} 222, and may output a signal indicating whether the first product is zero. Second zero detection gate 232 may receive second zero-activation indicator Z_{A1} 224 and second zero-weight indicator Z_{W1} 226, and may output a signal indicating whether the second product is zero. First zero detection gate 230 and second zero detection gate 232 may be implemented as OR gates, such that a product is indicated as zero when either corresponding operand is zero.

Selector 208 may be coupled to first multiplier 202, second multiplier 204, adder 206, and a zero output line 210. Selector 208 may be configured to select an output based on the control signals from first zero detection gate 230 and second zero detection gate 232. Selector 208 may select from four possible outputs: a zero value from zero output line 210, the first product from first multiplier 202, the second product from second multiplier 204, or the sum from adder 206. When both zero detection gates 230 and 232 indicate that both products are zero, selector 208 may output the zero value from zero output line 210. When first zero detection gate 230 indicates the first product is zero and second zero detection gate 232 indicates the second product is non-zero, selector 208 may output the second product. When first zero detection gate 230 indicates the first product is non-zero and second zero detection gate 232 indicates the second product is zero, selector 208 may output the first product. When both products are non-zero, selector 208 may output the sum from adder 206. The selected output may be provided to multiply-accumulate output 228.

Multiply-accumulate unit 200 may further include power gating circuitry configured to selectively disable power to computational elements based on the zero indicators. First multiplier 202 may be power gated based on first zero-weight indicator Z_{W0} 222, and second multiplier 204 may be power gated based on second zero-weight indicator Z_{W1} 226. Because weight inputs W₀ 216 and W₁ 218 remain stationary during operation, the power gating state for multipliers 202 and 204 may be set when weight values are loaded and may remain constant while successive activation values are processed. Adder 206 may be power gated when first zero-weight indicator Z_{W0} 222 or second zero-weight indicator Z_{W1} 226 indicates a zero weight, because at least one product will be zero and adder 206 may pass through the non-zero product or output zero. Power gating based on zero-activation indicators Z_{A0} 220 and Z_{A1} 224 may be omitted because activation values are dynamic, and changing power gating states on dynamic inputs may increase power consumption and delay.

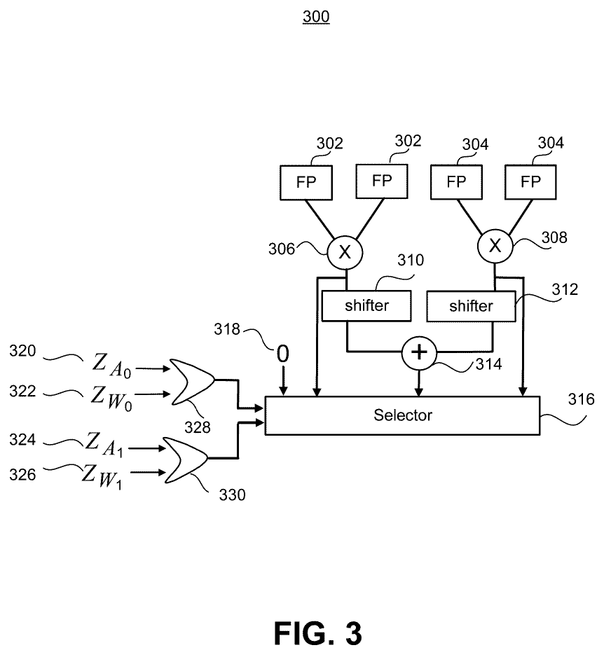

FIG. 3 illustrates a diagram of an example of a floating-point multiply-accumulate unit 300 with alignment circuitry and zero detection, in accordance with some aspects of the present technology. Floating-point multiply-accumulate unit 300 may be an alternative implementation of multiply-accumulate unit 200 (FIG. 2) configured for floating-point operations. As shown in FIG. 3, floating-point multiply-accumulate unit 300 may include a first multiplier 306, a second multiplier 308, a first shifter 310, a second shifter 312, an adder 314, a selector 316, and zero detection gates 328 and 330.

Floating-point multiply-accumulate unit 300 may receive a first floating-point operand pair 302 and a second floating-point operand pair 304. First floating-point operand pair 302 may include a first activation value and a first weight value in floating-point format. Second floating-point operand pair 304 may include a second activation value and a second weight value in floating-point format. In some embodiments, the activation values and weight values may include block floating-point values with shared scales, where multiple values share a common exponent or scale factor.

First multiplier 306 may be coupled to first floating-point operand pair 302 and configured to produce a first floating-point product. Second multiplier 308 may be coupled to second floating-point operand pair 304 and configured to produce a second floating-point product. The floating-point products from first multiplier 306 and second multiplier 308 may be provided to first shifter 310 and second shifter 312, respectively, for alignment before summation.

First shifter 310 and second shifter 312 may be alignment circuitry configured to align the floating-point products from first multiplier 306 and second multiplier 308. As used herein, alignment circuitry refers to shifting logic that adjusts the mantissa of a floating-point value based on exponent differences to enable proper addition of floating-point products. First shifter 310 may receive the first floating-point product from first multiplier 306 and shift the mantissa based on exponent alignment requirements. Second shifter 312 may receive the second floating-point product from second multiplier 308 and perform corresponding mantissa shifting. The aligned products from first shifter 310 and second shifter 312 may be provided to adder 314.

Adder 314 may be coupled to first shifter 310 and second shifter 312, and configured to sum the aligned floating-point products to produce a sum. Similar to adder 206 (FIG. 2), adder 314 may be configured to pass through an input when another input to adder 314 is zero.

Floating-point multiply-accumulate unit 300 may include zero detection circuitry configured to generate zero indicators based on the floating-point operand values. As shown in FIG. 3, the zero indicators may include a first zero-activation indicator Z_{A0} 320, a first zero-weight indicator Z_{W0} 322, a second zero-activation indicator Z_{A1} 324, and a second zero-weight indicator Z_{W1} 326. The zero detection circuitry may determine whether each floating-point operand is equal to zero based on the exponent and mantissa fields of the floating-point value.

First zero detection gate 328 and second zero detection gate 330 may be configured to generate control signals for selector 316 based on the zero indicators. First zero detection gate 328 may receive first zero-activation indicator Z_{A0} 320 and first zero-weight indicator Z_{W0} 322, and may output a signal indicating whether the first product is zero. Second zero detection gate 330 may receive second zero-activation indicator Z_{A1} 324 and second zero-weight indicator Z_{W1} 326, and may output a signal indicating whether the second product is zero. First zero detection gate 328 and second zero detection gate 330 may be implemented as OR gates, such that a product is indicated as zero when either corresponding operand is zero.

Selector 316 may be coupled to first multiplier 306, second multiplier 308, adder 314, and a zero output line 318. Selector 316 may be configured to select an output based on the control signals from first zero detection gate 328 and second zero detection gate 330. Similar to selector 208 (FIG. 2), selector 316 may select from a zero value from zero output line 318, a product from one of the multipliers 306 or 308, or the sum from adder 314. In addition to selecting the output, selector 316 may be configured to bypass first shifter 310 and second shifter 312 based on the zero indicators. When a product is predetermined to be zero, the corresponding shifter need not perform alignment operations, and selector 316 may route an alternative value directly to the output. This bypass capability reduces power consumption by avoiding unnecessary shifting operations.

Floating-point multiply-accumulate unit 300 may include power gating circuitry configured to selectively disable power to computational elements based on the zero indicators. First multiplier 306 may be power gated based on first zero-weight indicator Z_{W0} 322, and second multiplier 308 may be power gated based on second zero-weight indicator Z_{W1} 326. First shifter 310 and second shifter 312 may also be power gated based on the zero-weight indicators. Because weight values remain stationary during operation, the power gating states for multipliers 306 and 308 and shifters 310 and 312 may be set when weight values are loaded and may remain constant while successive activation values are processed. Adder 314 may be power gated when either zero-weight indicator indicates a zero weight.

In some implementations, the floating-point multiplication in floating-point multiply-accumulate unit 300 may be computed as follows. For a floating-point activation value A and a floating-point weight value W, the product P may be expressed as P=A×W=((−1)^{S}^{_{A}}×2^{E}^{_{A}}×M_{A})×((−1)^{S}^{_{W}}×2^{E}^{_{W}}×M_{W}), where S_{A} and S_{W} represent the sign bits, E_{A} and E_{W} represent the exponents, and M_{A} and M_{W} represent the mantissas of the activation and weight values respectively. The product P may be written as P=(−1)^{S}^{_{P}}×2^{E}^{_{P}}×M_{P}, where the product sign S_{P}=S_{A}⊕S_{W} is computed by XOR of the operand signs, the product exponent E_{P}=E_{A}+E_{W} is computed by addition of the operand exponents, and the product mantissa M_{P}=M_{A}×M_{W} is computed by multiplication of the operand mantissas. For alignment before addition, the product may be expressed as P=(−1)^{S}^{_{P}}×(M_{P}<<E_{P}), where the shift operation aligns the mantissa based on the exponent value. The output sum Y may be computed as Y=P₀+P₁, where P₀ and P₁ represent the aligned first and second products. Selector 316 may receive inputs including a zero value from zero output line 318, the first product P₀, the second product P₁, and the sum Y, and may select among these inputs based on zero indicators Z_{A0} 320, Z_{W0} 322, Z_{A1} 324, and Z_{W1} 326.

In some implementations, the floating-point multiplication circuitry may handle subnormal values. In floating-point representation, a normal value has a non-zero exponent field and an implicit leading bit of one in the mantissa. A subnormal value has an exponent field of all zeros and an implicit leading bit of zero, enabling representation of values smaller than the minimum normal value. To form the correct mantissa for multiplication, the multiplication circuitry may compute a bitwise OR of the exponent field bits to determine the implicit leading bit. If the bitwise OR result is zero, the exponent field is all zeros, and the implicit leading bit is zero. If the bitwise OR result is one, the exponent field contains at least one non-zero bit, and the implicit leading bit is one. The effective mantissa used in multiplication may be computed by concatenating the bitwise OR result as the implicit leading bit with the explicit mantissa bits. The zero detection circuitry may separately determine whether a floating-point operand is zero by checking whether both the exponent field and the mantissa field are all zeros.

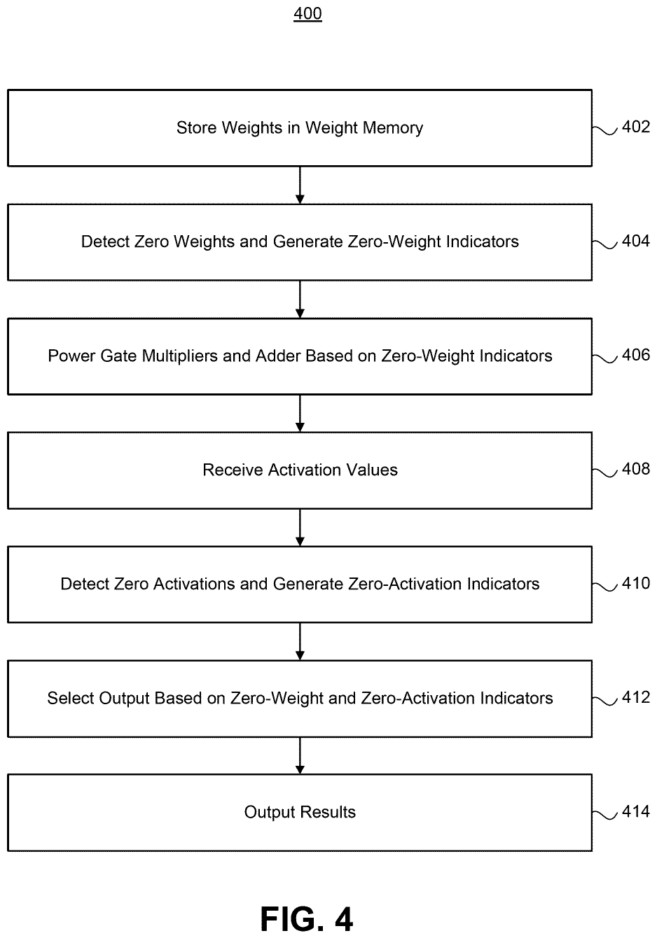

FIG. 4 illustrates a flow chart of an example of a method 400 for performing VMM with reduced power consumption, in accordance with some aspects of the present technology. Method 400 may be performed using DCIM system 100 (FIG. 1), multiply-accumulate unit 200 (FIG. 2), or floating-point multiply-accumulate unit 300 (FIG. 3). Method 400 may include steps 402 through 414 as described below.

At step 402, weight values may be stored in a weight memory. The weight values may be loaded from main memory or high-bandwidth memory (HBM) into weight memory 106 (FIG. 1). In a weight-stationary dataflow, the weight values may be loaded once and remain stored in the weight memory while successive sets of activation values are processed. The weight values may be arranged as a matrix for VMM operations.

At step 404, zero weights may be detected and zero-weight indicators may be generated. Zero detection circuitry may access each weight value stored in the weight memory and generate a corresponding zero-weight indicator. The zero-weight indicators may respectively correspond to the weight values, such that each zero-weight indicator indicates whether its corresponding weight value is equal to zero. Because the weight values remain stationary during operation, step 404 may be performed once when weight values are loaded at step 402, and the zero-weight indicators may remain valid while successive activation values are processed.

At step 406, multipliers and adders may be power gated based on the zero-weight indicators. Power gating circuitry may selectively disable power to multipliers corresponding to zero-weight values. For example, as shown in FIG. 2, first multiplier 202 may be power gated based on first zero-weight indicator Z_{W0} 222, and second multiplier 204 may be power gated based on second zero-weight indicator Z_{W1} 226. Adder 206 may be power gated when at least one of the zero-weight indicators indicates a zero weight. Because step 406 is based on stationary weight values, the power gating state may be set once and may remain constant while successive activation values are processed. This static power gating approach avoids the increased power consumption and delay that would result from changing power gating states on dynamic inputs.

At step 408, activation values may be received in an input register. The activation values may be streamed from main memory or a previous processing stage into input register 102 (FIG. 1). In a weight-stationary dataflow, step 408 may be repeated for successive sets of activation values while the weight values remain stored in the weight memory. The activation values may be provided to the multipliers for multiplication with the stored weight values.

At step 410, zero activations may be detected and zero-activation indicators may be generated. Zero detection circuitry may access each activation value received in the input register and generate a corresponding zero-activation indicator. The zero-activation indicators may respectively correspond to the activation values, such that each zero-activation indicator indicates whether its corresponding activation value is equal to zero. Unlike the zero-weight indicators generated at step 404, the zero-activation indicators may be generated dynamically for each new set of activation values received at step 408.

At step 412, an output may be selected based on the zero-weight indicators and the zero-activation indicators. Selector circuitry may determine which output to provide based on which operands are zero. As described with reference to FIG. 2, selector 208 may select from four possible outputs: a zero value, a first product, a second product, or a sum from the adder. When both zero-weight indicators and zero-activation indicators indicate that all products are zero, the selector may output a zero value directly without requiring computation by the multipliers and adder. When one product is zero and another is non-zero, the selector may output the non-zero product. When both products are non-zero, the selector may output the sum from the adder. This selection enables computational bypass when operands are zero, reducing switching activity and power consumption.

At step 414, results may be output. The selected output from step 412 may be stored in an output register, such as output register 114 (FIG. 1). The results may be provided to subsequent processing stages or written back to memory. In some embodiments, after step 414, method 400 may return to step 408 to receive the next set of activation values, with steps 408 through 414 repeated for successive activation vectors while the weight values remain stationary.

Method 400 may be performed iteratively to process multiple output elements of a VMM. After completing steps 402 through 414 for a first set of weight values, method 400 may return to step 402 to load a next set of weight values for computing additional output elements. Alternatively, the weight values may remain stored while method 400 processes multiple input vectors, with steps 408 through 414 repeated for each input vector to produce a corresponding output vector. This iterative operation enables efficient processing of batched inference workloads where multiple input samples are processed using the same weight values.

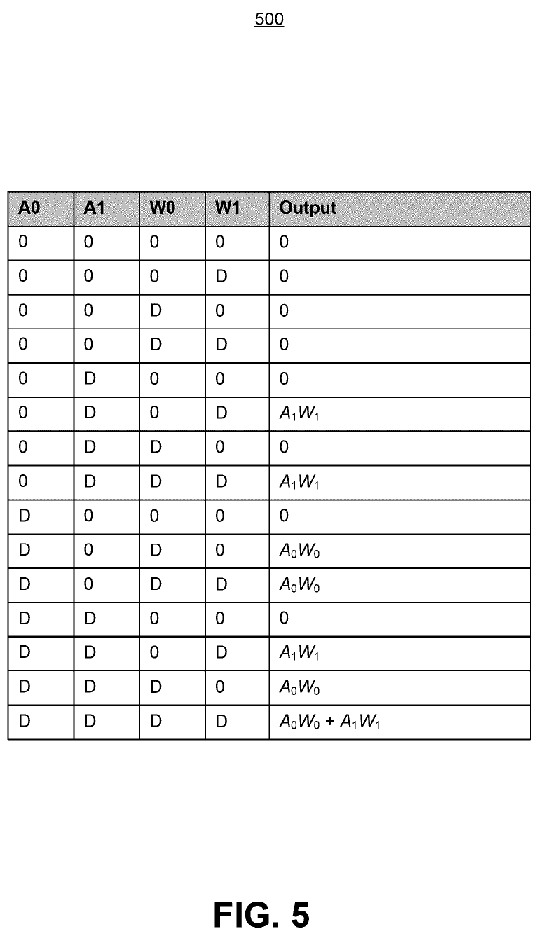

FIG. 5 illustrates a table 500 of an example of selector logic for multiply-accumulate unit 200 (FIG. 2) or floating-point multiply-accumulate unit 300 (FIG. 3), in accordance with some aspects of the present technology. Table 500 shows the output selection based on zero indicators for the weight values and activation values.

As shown in FIG. 5, table 500 includes columns for the output value, a first weight indicator W₀, a second weight indicator W₁, a first activation indicator A₀, and a second activation indicator A₁. Each indicator may have a value of zero (0) or non-zero (D). The output column shows the selected output value based on the combination of zero indicators.

When all indicators are zero (W₀=0, W₁=0, A₀=0, A₁=0), the output is zero because all products are zero. When W₀ is zero or A₀ is zero, the first product A₀W₀ is zero regardless of the other operand. Similarly, when W₁ is zero or A₁ is zero, the second product A₁W₁ is zero. When both products are zero, the output is zero. When only one product is non-zero, selector 208 (FIG. 2) or selector 316 (FIG. 3) may output that non-zero product directly, bypassing the adder. When both products are non-zero (W₀=D, W₁=D, A₀=D, A₁=D), the output is the sum A₀W₀+A₁W₁ from adder 206 (FIG. 2) or adder 314 (FIG. 3).

Table 500 illustrates that selector circuitry may be implemented using a lookup table configured to determine the appropriate output based on the zero indicators. This selection mechanism enables computational bypass when one or more operands are zero, reducing switching activity and power consumption without affecting computational accuracy.

The selector logic illustrated in table 500 may be implemented in hardware using various approaches. In some implementations, the selector logic may be implemented as a read-only memory or lookup table addressed by the zero indicators. In other implementations, the selector logic may be implemented using combinational logic gates that directly compute the selection based on the zero indicator values. The selector logic may further include priority encoding to resolve cases where multiple valid outputs exist, ensuring deterministic output selection for all combinations of zero indicators.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

A number of implementations have been described. Nevertheless, it will be understood that various modifications may be made without departing from the spirit and scope of the disclosure. Accordingly, other implementations are within the scope of the following claims.

It is understood that the described systems or apparatuses are not mutually exclusive, and elements, components, materials, or steps described in connection with one example method, system, or apparatus may be combined with, or eliminated from, other disclosed methods, systems, or apparatuses in suitable ways to accomplish desired design objectives.

In the foregoing specification, the disclosed systems or apparatuses have been described with reference to numerous specific details that can vary from implementation to implementation. Certain adaptations and modifications of the described systems or apparatuses can be made. Various renditions of the disclosed systems or apparatuses can be apparent to those skilled in the art from consideration of the specification and practice of the invention disclosed herein. It is intended that the specification and examples be considered as exemplary only.

It should be understood that the various embodiments described herein are not mutually exclusive and may be combined, modified, or interchanged in whole or in part without departing from the scope of the disclosed technology. Features illustrated or described in connection with one embodiment may be incorporated into other embodiments to form additional implementations. For example, zero detection circuitry configurations, selector circuitry arrangement, power gating designs, and alignment bypass mechanisms, described with respect to any of FIGS. 1-5 may be selectively integrated to achieve desired power efficiency, computational throughput, or neural network inference performance. Accordingly, the disclosed technology encompasses all such combinations and variations that fall within the spirit and scope of the appended claims.

The present technology includes devices, apparatuses, and assemblies addressed in the aspects of the present technology presented below:

Aspect I: A computing system, including:
a weight memory configured to store a plurality of weight values;
an input register configured to receive a plurality of activation values;
a plurality of multipliers coupled to the weight memory and the input register;
at least one adder tree coupled to the plurality of multipliers;
zero detection circuitry configured to generate:
   zero-weight indicators based on the plurality of weight values; and
   zero-activation indicators based on the plurality of activation values; and
selector circuitry coupled to the plurality of multipliers and the at least one adder tree, the selector circuitry configured to select an output based on the zero-weight indicators and the zero-activation indicators.

Aspect II: The computing system of Aspect I, wherein:
the system includes an output register; and
the selector circuitry is configured to output a zero value via the output register when the zero-weight indicators and the zero-activation indicators indicate that all products of the plurality of multipliers are zero.

Aspect III: The computing system of Aspects I-II, wherein the at least one adder tree includes a plurality of adders, and each adder is associated with a multiplexer configured to selectively output a first input to bypass the adder when a second input to the adder is zero.

Aspect IV: The computing system of any of Aspects I-III, further including power gating circuitry coupled to at least a portion of the plurality of multipliers and configured to power gate a multiplier of the plurality of multipliers based on a corresponding zero-weight indicator.

Aspect V: The computing system of Aspect IV, wherein the power gating circuitry is configured to power gate an adder of the at least one adder tree when the adder is configured to pass through an input.

Aspect VI: The computing system of Aspect IV, wherein the power gating circuitry is configured to set a power gating state when the weight values are loaded into the weight memory.

Aspect VII: The computing system of any of Aspects I-VI, wherein the weight memory is configured to store the plurality of weight values, and the input register receives successive sets of the activation values.

Aspect VIII: The computing system of any of Aspects I-VII, wherein the plurality of multipliers comprises floating-point multiplication circuitry including alignment circuitry, and wherein the alignment circuitry is configured to be bypassed by the selector circuitry based on the zero-weight indicators and the zero-activation indicators.

Aspect IX: The computing system of Aspect VIII, wherein the alignment circuitry is configured to be power gated based on the zero-weight indicators.

Aspect X: The computing system of any of Aspects I-IX, wherein the plurality of weight values and the plurality of activation values include block floating-point values sharing common scales.

Aspect XI: A method for performing vector-matrix multiplication, the method including:
storing a plurality of weight values in a weight memory;
receiving a plurality of activation values in an input register;
generating zero-weight indicators for the plurality of weight values;
generating zero-activation indicators for the plurality of activation values;
multiplying the plurality of activation values by the plurality of weight values using a plurality of multipliers;
summing products from the plurality of multipliers using at least one adder tree; and
selecting an output based on the zero-weight indicators and the zero-activation indicators.

Aspect XII: The method of Aspect XI, wherein the plurality of weight values are maintained stationary in the weight memory while the input register receives successive sets of the activation values.

Aspect XIII: The method of any of Aspects XI-XII, further including passing an input value through at least one adder of the at least one adder tree based on the zero-weight indicators or the zero-activation indicators.

Aspect XIV: The method of any of Aspects XI-XIII, further including setting a power gating state of at least one multiplier of the plurality of multipliers based on the zero-weight indicators when storing the plurality of weight values in the weight memory.

Aspect XV: A multiply-accumulate unit including:
weight storage storing a plurality of weight values;
a plurality of multipliers coupled to the weight storage, and configured to receive a plurality of activation values;
an adder coupled to the plurality of multipliers;
zero detection circuitry configured to generate zero-weight indicators based on the plurality of weight values and zero-activation indicators based on the plurality of activation values; and
selector circuitry coupled to the plurality of multipliers and the adder, the selector circuitry configured to select an output based on the zero-weight indicators and the zero-activation indicators.

Aspect XVI: The multiply-accumulate unit of Aspect XV, wherein the selector circuitry is configured to select the output from:
a zero value,
a product from one of the plurality of multipliers, or
an output of the adder.

Aspect XVII: The multiply-accumulate unit of any of Aspects XV-XVI, further including power gating circuitry configured to gate at least one of the plurality of multipliers or the adder based on the zero-weight indicators.

Aspect XVIII: The multiply-accumulate unit of any of Aspects XV-XVII, further including alignment circuitry coupled with the plurality of multipliers and the adder, and configured to align products from the plurality of multipliers, wherein the selector circuitry is further configured to bypass the alignment circuitry based on the zero-weight indicators and the zero-activation indicators.

Aspect XIX: The multiply-accumulate unit of any of Aspects XV-XVIII, wherein the plurality of weight values and the plurality of activation values comprise block floating-point values with shared scales.

Aspect XX: The multiply-accumulate unit of any of Aspects XV-XIX, wherein the plurality of weight values are maintained stationary in the weight storage while the plurality of multipliers receive successive sets of the activation values.

Aspect XXI: The computing system of any of Aspects I-X, wherein the zero-weight indicators respectively correspond to the plurality of weight values and the zero-activation indicators respectively correspond to the plurality of activation values.

Aspect XXII: The computing system of any of Aspects I-X and XXI, wherein the selector circuitry is configured to select the output from:
a zero value,
a product from one of the plurality of multipliers, or
an output of the at least one adder tree.

What is claimed is:

1. A computing system, comprising:
a weight memory configured to store a plurality of weight values;
an input register configured to receive a plurality of activation values;
a plurality of multipliers coupled to the weight memory and the input register;
at least one adder tree coupled to the plurality of multipliers;
zero detection circuitry configured to generate:
zero-weight indicators based on the plurality of weight values, and
zero-activation indicators based on the plurality of activation values; and
selector circuitry coupled to the plurality of multipliers and the at least one adder tree, the selector circuitry configured to select an output based on the zero-weight indicators and the zero-activation indicators.

2. The computing system of claim 1, wherein:
the system comprises an output register; and
the selector circuitry is configured to output a zero value via the output register when the zero-weight indicators and the zero-activation indicators indicate that all products of the plurality of multipliers are zero.

3. The computing system of claim 1, wherein:
the at least one adder tree comprises a plurality of adders, and
each adder is associated with a multiplexer configured to selectively output a first input to bypass the adder when a second input to the adder is zero.

4. The computing system of claim 1, further comprising power gating circuitry coupled to at least a portion of the plurality of multipliers and configured to power gate a multiplier of the plurality of multipliers based on a corresponding zero-weight indicator.

5. The computing system of claim 4, wherein the power gating circuitry is configured to power gate an adder of the at least one adder tree when the adder is configured to pass through an input.

6. The computing system of claim 4, wherein the power gating circuitry is configured to set a power gating state when the weight values are loaded into the weight memory.

7. The computing system of claim 1, wherein:
the weight memory is configured to store the plurality of weight values, and
the input register receives successive sets of the plurality of activation values.

8. The computing system of claim 1, wherein:
the plurality of multipliers comprises floating-point multiplication circuitry including alignment circuitry; and
the alignment circuitry is configured to be bypassed by the selector circuitry based on the zero-weight indicators and the zero-activation indicators.

9. The computing system of claim 8, wherein the alignment circuitry is configured to be power gated based on the zero-weight indicators.

10. The computing system of claim 1, wherein the plurality of weight values and the plurality of activation values comprise block floating-point values sharing common scales.

11. A method for performing vector-matrix multiplication, comprising:
storing a plurality of weight values in a weight memory;
receiving a plurality of activation values in an input register;
generating zero-weight indicators for the plurality of weight values;
generating zero-activation indicators for the plurality of activation values;
multiplying the plurality of activation values by the plurality of weight values using a plurality of multipliers;
summing products from the plurality of multipliers using at least one adder tree; and
selecting an output based on the zero-weight indicators and the zero-activation indicators.

12. The method of claim 11, wherein the plurality of weight values are maintained stationary in the weight memory while the input register receives successive sets of the activation values.

13. The method of claim 11, further comprising passing an input value through at least one adder of the at least one adder tree based on the zero-weight indicators or the zero-activation indicators.

14. The method of claim 11, further comprising setting a power gating state of at least one multiplier of the plurality of multipliers based on the zero-weight indicators when storing the plurality of weight values in the weight memory.

15. A multiply-accumulate unit comprising:
weight storage storing a plurality of weight values;
a plurality of multipliers coupled to the weight storage, and configured to receive a plurality of activation values;
an adder coupled to the plurality of multipliers;
zero detection circuitry configured to generate zero-weight indicators based on the plurality of weight values and zero-activation indicators based on the plurality of activation values; and
selector circuitry coupled to the plurality of multipliers and the adder, the selector circuitry configured to select an output based on the zero-weight indicators and the zero-activation indicators.

16. The multiply-accumulate unit of claim 15, wherein the selector circuitry is configured to select the output from:
a zero value,
a product from one of the plurality of multipliers, or
an output of the adder.

17. The multiply-accumulate unit of claim 15, further comprising power gating circuitry configured to gate at least one of the plurality of multipliers or the adder based on the zero-weight indicators.

18. The multiply-accumulate unit of claim 15, further comprising alignment circuitry coupled with the plurality of multipliers and the adder, and configured to align products from the plurality of multipliers, wherein the selector circuitry is further configured to bypass the alignment circuitry based on the zero-weight indicators and the zero-activation indicators.

19. The multiply-accumulate unit of claim 15, wherein the plurality of weight values and the plurality of activation values comprise block floating-point values with shared scales.

20. The multiply-accumulate unit of claim 15, wherein the plurality of weight values are maintained stationary in the weight storage while the plurality of multipliers receive successive sets of the activation values.
